(19) United States
(12) Patent Application Publication
(10) Pub. No.: US 2014/0125928 A1
(43) Pub. Date: May 8, 2014

(54) Liquid Crystal Cell and Liquid Crystal Display

(71) Applicant: Shenzhen China Star Optoelectronics Technology Co. Ltd, Shenzhen Guangdong (CN)

(72) Inventor: Chih-Wen Chen, Shenzhen City (CN)

(73) Assignee: Shenzhen China Star Optoelectronics Technology Co., Ltd., Shenzhen,Guangdong (CN)

(21) Appl. No.: 13/700,674

(22) PCT Filed: Nov. 8, 2012
(86) PCT No.: PCT/CN2012/084310

§ 371 Date: Nov. 28, 2012

(30) Foreign Application Priority Data
Nov. 6, 2012 (CN) 201210438495.7

(51) Int. Cl. G02F 1/1335

(52) U.S. Cl. CPC G02F 1/133514
USPC 349/106

(57) ABSTRACT

A liquid crystal cell is disclosed. The liquid crystal cell includes a color filter substrate, an active array substrate spaced from the color filter substrate, and optical lenses arranged adjacent to the color filter substrate. A liquid crystal display includes the liquid crystal cells is also disclosed. The lens power of the liquid crystal cell is increased and the thickness of the liquid crystal cell is reduced.

### BACKGROUND OF THE INVENTION

1. Field of the Invention

Embodiments of the present disclosure relate to liquid crystal display technology, and more particularly to a liquid crystal cell and a liquid crystal display.

2. Discussion of the Related Art

With technology development of liquid crystal displays, the power consumption and display performance are greatly enhanced. As expected, more and more advanced technologies will be applied to the liquid crystal displays.

In a typical liquid crystal display, thicker liquid crystal displays are designed to enhance lens power. However, such design not only goes against lighter and thinner trend of liquid crystal displays, but also results in a higher manufacture cost.

### SUMMARY

The object of the claimed invention is to provide a liquid crystal cell and a liquid crystal display. The lens power of the liquid crystal cell is increased. In addition, the thickness and the cost of the liquid crystal cell are reduced.

In one aspect, a liquid crystal display includes liquid crystal cells. Each of the liquid crystal cell includes: a color filter substrate and an active array substrate spaced from the color filter substrate; optical lenses arranged adjacent to the color filter substrate, and each of the optical lenses includes an arcuate surface: a liquid crystal layer between the color filter substrate and the active array substrate; and wherein the optical lenses are arranged in a first surface of the color filter substrate, and the first surface is farther to the active array substrate than a second surface, the arcuate surfaces of the optical lenses face away from the color filter substrate, or the optical lenses are arranged on the second surface of the color filter substrate and the arcuate surfaces of the optical lenses face away from the active array substrate.

Wherein the liquid crystal display includes a plurality of optical lenses.

In another aspect, a liquid crystal cell includes: a color filter substrate and an active array substrate spaced from the color filter substrate; and optical lenses arranged adjacent to the color filter substrate, and each of the optical lenses includes an arcuate surface.

Wherein the optical lenses are arranged on a first surface of the color filter substrate, and the first surface is farther to the active array substrate than a second surface, the arcuate surfaces of the optical lenses face away from the color filter substrate.

Wherein the optical lenses are arranged on a second surface of the color filter substrate, and the second surface is closer to the active array substrate than a first surface, and the arcuate surfaces of the optical lenses face away from the active array substrate.

Wherein the liquid crystal display includes a plurality of optical lenses.

Wherein the liquid crystal cell further includes a liquid crystal layer between the color filter substrate and the active array substrate.

In another aspect, a liquid crystal display includes liquid crystal cells. Each of the liquid crystal cells includes: a color filter substrate and an active array substrate spaced from the color filter substrate; and optical lenses arranged adjacent to the color filter substrate, and each of the optical lenses includes an arcuate surface.

Wherein the optical lenses are arranged on a first surface of the color filter substrate, and the first surface is farther to the active array substrate than a second surface, the arcuate surfaces of the optical lenses faces away from the color filter substrate.

Wherein the optical lenses are arranged on a second surface of the color filter substrate, and the second surface is closer to the active array substrate than the first surface, and the arcuate surfaces of the optical lenses face away from the active array substrate.

Wherein the liquid crystal display includes a plurality of optical lenses.

Wherein the liquid crystal cell further includes a liquid crystal layer between the color filter substrate and the active array substrate.

### BRIEF DESCRIPTION OF THE DRAWINGS

FIG. 1a is a partial schematic view of a liquid crystal cell in a 3D mode in accordance with a first embodiment.

FIG. 1b is a partial schematic view of the liquid crystal cell of FIG. 1a in a 2D mode.

FIG. 2a is a partial schematic view of a liquid crystal cell in the 3D mode in accordance with a second embodiment.

FIG. 2b is a partial schematic view of a liquid crystal cell of FIG 2a.

### DETAILED DESCRIPTION OF THE EMBODIMENTS

Embodiments of the invention will now be described more fully hereinafter with reference to the accompanying drawings, in which embodiments of the invention are shown.

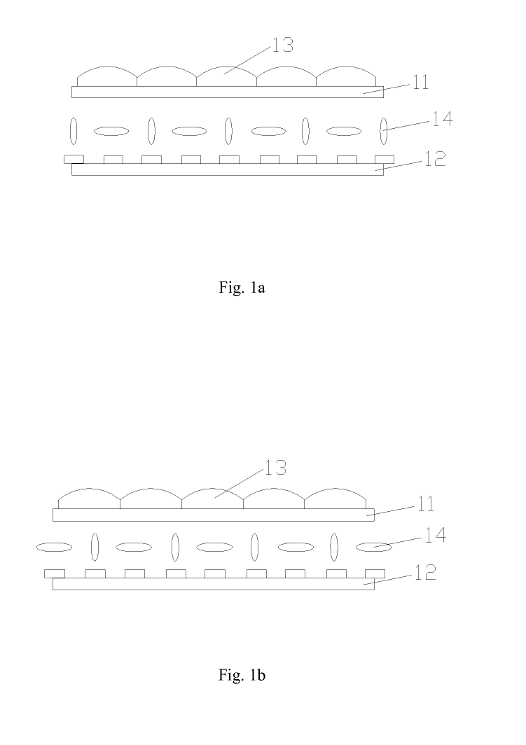

FIG. 1a is a partial schematic view of a liquid crystal cell in a 3D mode in accordance with a first embodiment. In the embodiment, the liquid crystal cell includes, but not limited to, a color filter substrate 11, an active array substrate 12, a plurality of optical lenses 13, and a liquid crystal layer 14.

The color filter substrate 11 and the active array substrate 12 are spaced from each other. The liquid crystal layer 14 is between the color filter substrate 11 and the active array substrate 12. The optical lenses 13 are arranged adjacent to the color filter substrate 11. Specifically, the optical lenses 13 are arranged in a first surface of the color filter substrate 11, and the first surface is farther to the active array substrate 12 than a second surface. In addition, arcuate surfaces of the optical lenses 13 face away from the color filter substrate 11. The optical lenses 13 and the color filter substrate 11 may be assembled by a typical method. The number of the optical lenses 13 may be configured accordingly.

By adjusting a focal length of the lenses of the liquid crystal cell, the lens power of the liquid crystal cell is increased. In addition, the thickness and the cost of the liquid crystal cell are reduced.

The switch process between the 2D mode and the 3D mode will be described with reference to FIGS. 1a and 1b. FIG. 1b is a partial schematic view of the liquid crystal cell of FIG. 1a in the 2D mode.

The process of switching, from the 3D mode to the 2D mode may be accomplished by changing the voltage applied to the color filter substrate 11 and the active array substrate 12. The alignment of the liquid crystals on the liquid crystal layer 14 is changed so that the motions of the translation of the liquid crystals are equivalent. In this way, the impact occurred from the optical lenses 13 are reduced and thus display effect of the 2D mode is guaranteed.

By arranging the optical lenses 13 on the color filter substrate 11, the lens power of the liquid crystal cell is increased. In addition, the thickness and the cost of the liquid crystal cell are reduced.

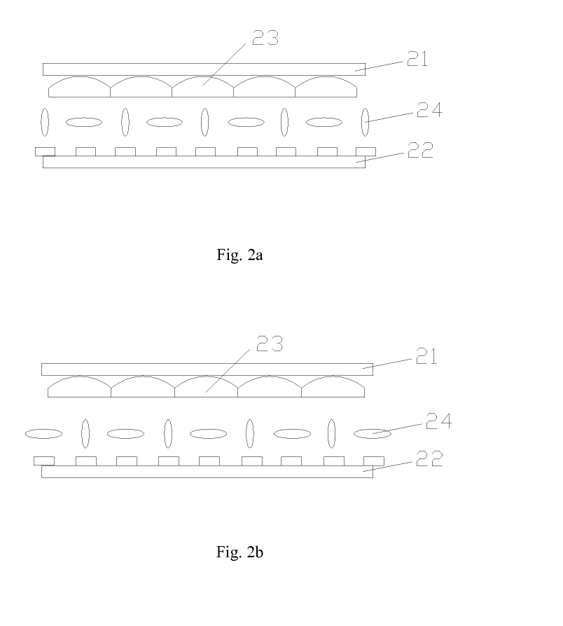

FIG. 2a is a partial schematic view of a liquid crystal cell in the 3D mode in accordance with a second embodiment.

In the embodiment, the liquid crystal cell includes the color filter substrate 21, the active array substrate 22, optical lenses 23, and a liquid crystal cell 24.

The color filter substrate 21 and the active array substrate 22 are spaced from each other. The liquid crystal layer 24 is between the color filter substrate 21 and the active array substrate 22. The optical lenses 23 are arranged adjacent to the color filter substrate 21. Specifically, the optical lenses 23 are arranged in the second surface of the color filter substrate 21, and the second surface is closer to the active array substrate 22 than the first surface. In addition, the arcuate surfaces of the optical lenses 23 face away from the active array substrate 22. The optical lenses 23 and the color filter substrate 21 may be assembled by one typical method. The number of the optical lenses 23 may be configured accordingly.

By adjusting the focal length of the lenses 23 of the liquid crystal cell, the lens power of the liquid crystal cell is increased. In addition, the thickness and the cost of the liquid crystal cell are reduced.

The switch process between the 2D mode and the 3D mode will be described with reference to FIGS. 2a and 2b. FIG. 2b is a partial schematic view of the liquid crystal cell of FIG. 2a in the 2D mode.

The process of switching from the 3D mode to the 2D mode may be accomplished by changing the voltage applied to the color filter substrate 21 and the array substrate 22 or by adding an additional electrode array. The alignment of the liquid crystals on the liquid crystal layer 24 is changed so that the motions of the translation or the liquid crystals are equivalent. In this way, the impact toward the 2D mode occurred from arranging the optical lenses 23 are reduced and thus the display effect of the 2D mode is guaranteed.

By arranging, the optical lenses 23 on the color filter substrate 21, the lens power of the liquid crystal cell is increased. In addition, the thickness and the cost of the liquid crystal cell are reduced.

In one embodiment, a liquid crystal display includes the above-mentioned liquid crystal cells. The liquid crystal cell includes, but not limited to, the color filter substrate, the active array substrate, the optical lenses, and the liquid crystal layer.

The color filter substrate and the active array substrate are spaced from each other. The liquid crystal layer is between the color filter substrate and the active array substrate. The optical lenses are arranged adjacent to the color filter substrate. Specifically, the optical lenses are arranged in the first surface of the color filter substrate, and the first surface is farther to the active array substrate than the second surface. In addition, the arcuate surfaces of the optical lenses face away from the color filter substrate. The optical lenses and the color filter substrate may be assembled by one typical method.

In other embodiments, the optical lenses may be arranged on the second surface of the color filter substrate. That is, the optical lenses may be arranged between the color filter substrate and the liquid crystal layer. The arcuate surfaces of the optical lenses face away from the color filter substrate. It is to be understood that the optical lenses may also be arranged on other components of the liquid crystal display. The number of the optical lenses may be configured accordingly.

The process of switching from the 3D mode to the 2D mode is similar to the above-mentioned process.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display with liquid crystal cells, the liquid crystal cell comprising:
a color filter substrate and an active array substrate spaced from the color filter substrate;
optical lenses arranged adjacent to the color filter substrate, and each of the optical lenses comprises an arcuate surface;
a liquid crystal layer between the color filter substrate and the active array substrate; and
wherein the optical lenses are arranged in a first surface of the color filter substrate, and the first surface is farther to the active array substrate than a second surface, the arcuate surfaces of the optical lenses face away from the color filter substrate, or the optical lenses are arranged on the second surface of the color filter substrate and the arcuate surfaces of the optical lenses face away from the active array substrate.

2. The liquid crystal display as claimed in claim 1, wherein the liquid crystal display comprises a plurality of optical lenses.

3. A liquid crystal cell, comprising:
a color filter substrate and an active array substrate spaced from the color filter substrate; and
optical lenses arranged adjacent to the color filter substrate, and each of the optical lenses comprises an arcuate surface.

4. The liquid crystal cell as claimed in claim 3, wherein the optical lenses are arranged on a first surface of the color filter substrate, and the first surface is farther to the active array substrate than a second surface, the arcuate surfaces of the optical lenses face away from the color filter substrate.

5. The liquid crystal cell as claimed in claim 3, wherein the optical lenses are arranged on a second surface of the color filter substrate, and the second surface is closer to the active array substrate than a first surface, and the arcuate surfaces of the optical lenses face away from the active array substrate.

6. The liquid crystal cell as claimed in claim 3, wherein the liquid crystal display comprises a plurality of optical lenses.

7. The liquid crystal cell as claimed in claim 3, wherein the liquid crystal cell further comprises a liquid crystal layer between the color filter substrate and the active array substrate.

8. A liquid crystal display with liquid crystal cells, the liquid crystal cell comprising:
a color filter substrate and an active array substrate spaced from the color filter substrate; and
optical lenses arranged adjacent to the color filter substrate, and each of the optical lenses comprises an arcuate surface.

9. The liquid crystal display as claimed in claim 8, wherein the optical lenses are arranged on a first surface of the color filter substrate, and the first surface is farther to the active array substrate than a second surface, the arcuate surfaces of the optical lenses faces away from the color filter substrate.

10. The liquid crystal display as claimed in claim 8, wherein the optical lenses are arranged on a second surface of the color filter substrate, and the second surface is closer to the active array substrate than the first surface, and the arcuate surfaces of the optical lenses face away from the active array substrate.

11. The liquid crystal display as claimed in claim 8, wherein the liquid crystal display comprises a plurality of optical lenses.

12. The liquid crystal display as claimed in claim 10, wherein the liquid crystal cell further comprises a liquid crystal layer between the color filter substrate and the active array substrate.
